(19) United States
(12) Patent Application Publication
(10) Pub. No.: US 2024/0345720 A1
(43) Pub. Date: Oct. 17, 2024

(54) Electronic Devices and Corresponding Methods for Resizing Application Interface Portals for Presenting Notifications

(71) Applicant: Motorola Mobility LLC, Chicago, IL (US)

(72) Inventors: Gokula Ramanan, Bangalore (IN); Amit Kumar Agrawal, Bangalore (IN); Satyabrata Rout, Bhubaneswar (IN)

(21) Appl. No.: 18/134,008

(22) Filed: Apr. 12, 2023

(51) Int. Cl. G06F 3/04886; G06F 3/0482; G06F 9/54

(52) U.S. Cl. CPC G06F 3/04886; G06F 3/0482; G06F 9/542

(57) ABSTRACT

An electronic device includes a display and one or more processors operable with the display. In response to receipt of a notification for presentation on the display the one or more processors reduce an application interface portal being presented on the display by an application operating on the one or more processors to obtain a modified application interface portal. The one or more processors then present the notification and modified application interface portal in a non-overlapping arrangement.

### BACKGROUND

### Technical Field

This disclosure relates generally to electronic devices, and more particularly to electronic devices having displays.

### Background Art

The use of mobile electronic communication devices such as smartphones and tablet computers has become ubiquitous. Owners of these devices use them for a multitude of tasks, examples of which include voice communications, text messaging, Internet browsing, calendar management, commerce such as banking, and social networking.

As these devices become more sophisticated, they can also become more complicated to operate. Illustrating by example, many “smart devices” now come equipped with touch sensitive displays rather than physical keyboards. When a user is multi-tasking, these displays can become cluttered with windows, user actuation targets, icons and more. It would be advantageous to have improved electronic devices and corresponding methods that provide an improved user interface experience.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates an electronic device presenting a prior art user interface.

FIG. 3 illustrates one explanatory method in accordance with one or more embodiments of the disclosure.

FIG. 4 illustrates one or more method steps in accordance with one or more embodiments of the disclosure.

FIG. 5 illustrates one or more method steps in accordance with one or more embodiments of the disclosure.

FIG. 6 illustrates another explanatory method in accordance with one or more embodiments of the disclosure.

FIG. 7 illustrates one or more method steps in accordance with one or more embodiments of the disclosure.

FIG. 8 illustrates one or more method steps in accordance with one or more embodiments of the disclosure.

FIG. 9 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to resizing an application interface portal to create a modified application interface portal so that notifications can be presented adjacent to the modified application interface portal. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of reducing a presentation size of an application interface portal and presenting a notification adjacent to the application interface portal after resizing as described herein. The non-processor circuits may include, but are not limited to, a radio receiver, a radio transmitter, signal drivers, clock circuits, power source circuits, and user input devices.

As such, these functions may be interpreted as steps of a method to, in response to receipt of a notification for the presentation on a display, reducing an application interface portal being presented on the display and presenting the notification in a non-overlapping arrangement adjacent to the application interface portal. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide an electronic device and corresponding methods for reducing clutter on a display when notifications are received. In one or more embodiments, an electronic device comprises a display and one or more processors operable with the display. The electronic device also includes a communication device operable with the one or more processors.

In one or more embodiments, when an application operating on the one or more processors presents an application interface portal on the display when the communication device receives a notification, the one or more processors resize the application interface portal to create a modified application interface portal. Thereafter, the one or more processors present the notification on the display adjacent to the modified application interface portal. Advantageously, this allows the notification to be presented without overlapping the application interface portal. Thus, if a player were engrossed in a snowboarding video game and a notification from his mother to come and eat dinner was received, he could read the notification without disrupting the game. This allows him to still make dinner while catching some sick air and shredding the gnar on a tray crisscrossing the cords.

Embodiments of the disclosure contemplate that there are many instances where users want to get notified about incoming notifications but do not necessarily want to act at the moment when the notification is received. This is especially true when the user is doing something else on the electronic device, such as interacting with an application interface portal presented by an application operating on the one or more processors of the electronic device.

In prior art devices, incoming notifications are designed to be presented in a “heads up” manner where the notification considerably overlaps the application interface portal that is being presented in the foreground and that is actively being used. When these application interface portals are rich user interfaces with content or many user actuation targets, such as the case may be when a game is being played or a movie is being watched in an immersion mode, presenting an overlapping notification may not only be distracting to the user, but may prevent them from catching all the action or being able to access some user actuation targets. While such notifications can be blocked, in many instances this is just not convenient. Can you imagine if our boarder missed dinner when carving the pow because he didn't receive his mother's notification for dinner? It would have resulted in a radgnar grounding to be sure.

Advantageously, embodiments of the disclosure prevent this from happening. In one or more embodiments, a method in an electronic device comprises presenting, by one or more processors on a display, an application interface portal. When the one or more processors receive a notification, in one or more embodiments the one or more processors reduce a presentation size of the application interface portal and then present the notification adjacent to the application interface portal. In one or more embodiments, the notification and the application interface portal are therefore presented in a non-overlapping arrangement. This allows the application interface portal to be viewed in full while not missing out on the notification.

In one or more embodiments, one or more processors of an electronic device determine that the electronic device is being used to consume content via an application interface portal presented by an application operating on the one or more processors of the electronic device. The one or more processors can optionally determine that the content being consumed is media content while the device is docked, or that the content is gaming content when the user is actively interacting with the display of the electronic device.

In one or more embodiments, the one or more processors determine that an incoming notification is received, and that if presented in the traditional “heads up” presentation scheme, would overlap the application interface portal being presented on the display. In one or more embodiments, the one or more processors therefore determine an area amount of the display required for the presentation of the notification. In one or more embodiments, this area amount is what is required to present the notification after reducing the notification as much as possible without eliminating or reducing the content therein.

In one or more embodiments, the one or more processors then consider the remaining area of the display as the “new” area on which to present the application interface portal. This “new” area is effectively the total area of the display minus the area required to present the notification. It can be expressed as follows: “new” area equals the total area of the display minus the area required to present the notification.

In one or more embodiments, the one or more processors resize the application interface portal to the new area of the display and then present the notification in an adjacent, non-overlapping arrangement so that the application interface portal can be seen in full as can the notification. The notification gets shown in an isolated area that is complementary to the area occupied by the application interface portal.

In one or more embodiments, an electronic device comprises a display and one or more processors operable with the display. In one or more embodiments, the one or more processors, in response to receipt of a notification for presentation on the display, reduce an application interface portal being presented on the display and present the notification in a non-overlapping arrangement adjacent to the application interface portal. This can include, in some situations, creating a cutout in the application interface portal. Advantageously, this allows notifications such as incoming call notifications, alarm notifications, incoming message notifications, application notifications, and system notifications to be presented without obscuring application interface portals being presented on the display. Other advantages will be described below. Still others will be obvious to those of ordinary skill in the art having the benefit of this disclosure.

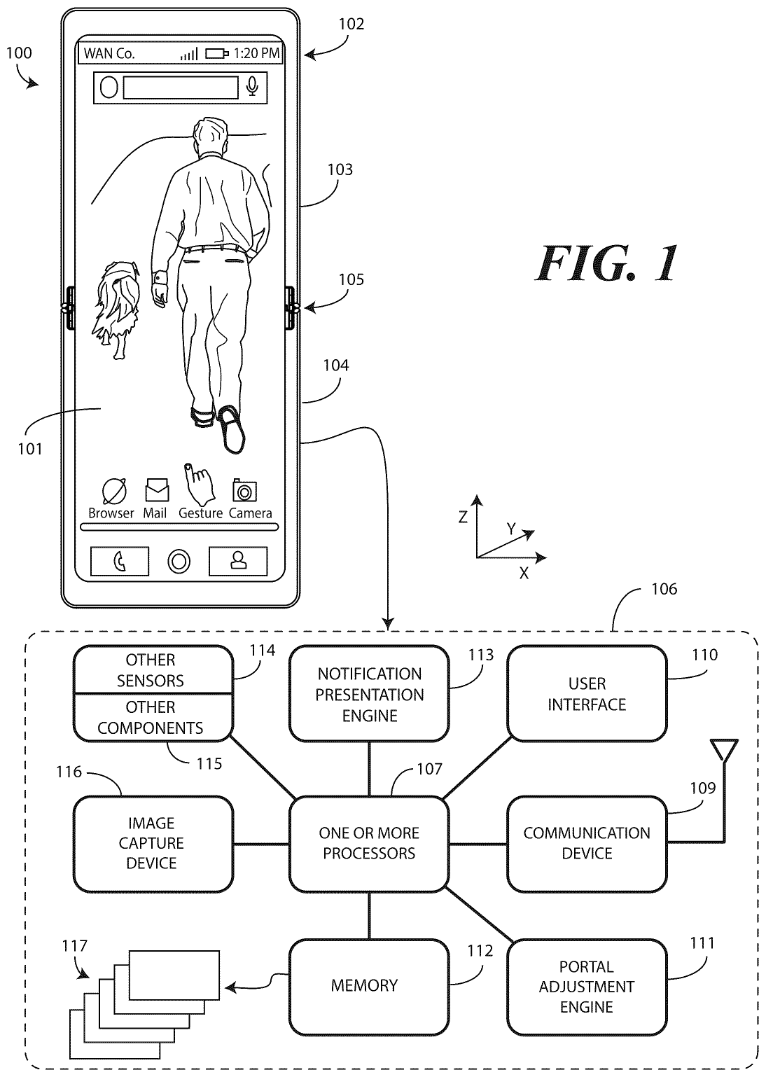

Turning now to FIG. 1, illustrated therein is one explanatory electronic device 100 configured in accordance with one or more embodiments of the disclosure. The electronic device 100 of FIG. 1 is a portable electronic device and is shown as a smartphone for illustrative purposes. However, it should be obvious to those of ordinary skill in the art having the benefit of this disclosure that other electronic devices may be substituted for the explanatory smart phone of FIG. 1. For example, the electronic device 100 could equally be a conventional desktop computer, palm-top computer, a tablet computer, a gaming device, a media player, or other device.

This illustrative electronic device 100 includes a display 101, which may optionally be touch sensitive. Users can deliver user input to the display 101, which serves as a user interface 110 for the electronic device 100. In one embodiment, users can deliver user input to the display 101 of such an embodiment by delivering touch input from a finger, stylus, or other objects disposed proximately with the display 101.

In one embodiment, the display 101 is configured as an active-matrix organic light emitting diode (AMOLED) display. However, it should be noted that other types of displays, including liquid crystal displays, would be obvious to those of ordinary skill in the art having the benefit of this disclosure.

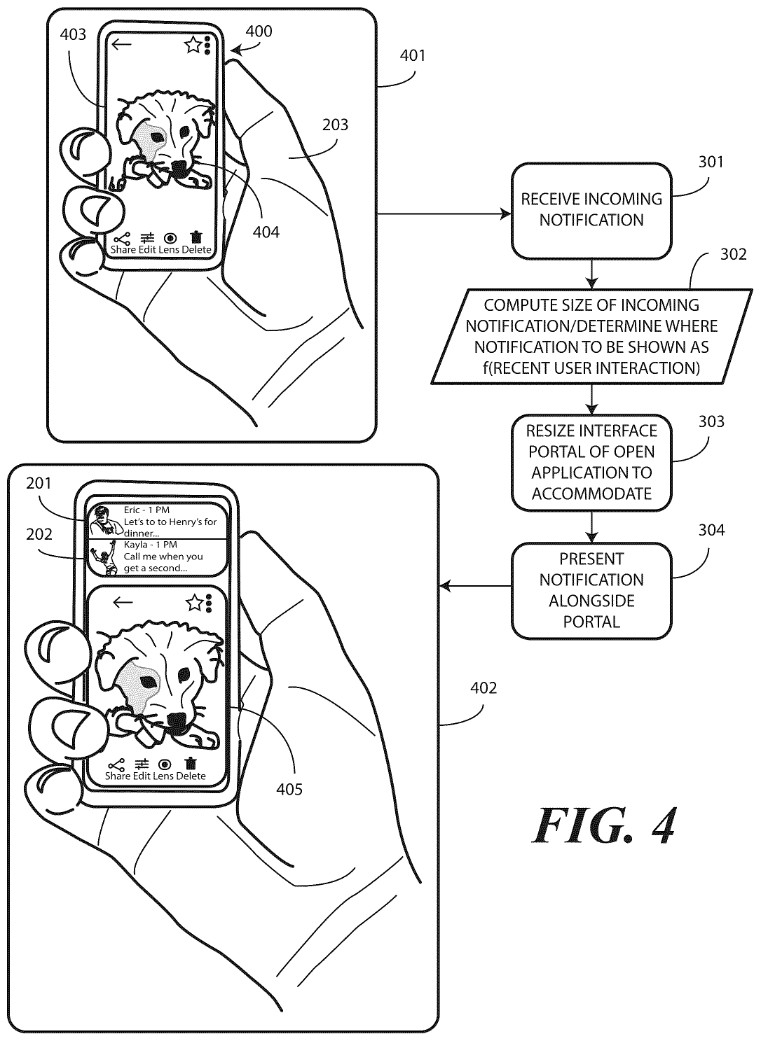

The explanatory electronic device 100 of FIG. 1 also includes a device housing 102. In one embodiment, the device housing 102 includes two housing members, namely, a first device housing 103 that is coupled to a second device housing 104 by a hinge 105 such that the first device housing 103 is pivotable about the hinge 105 relative to the second device housing 104 between a closed position and an axially displaced open position. In other embodiments, one example of which will be illustrated and described below with reference to FIG. 4, the device housing 102 will be rigid and will include no hinge.

In still other embodiments, the device housing 102 will be manufactured from a flexible material such that it can be bent and deformed. Where the device housing 102 is manufactured from a flexible material or where the device housing 102 includes a hinge, the display 101 can be manufactured on a flexible substrate such that it bends. In one or more embodiments, the display 101 is configured as a flexible display that is coupled to the first device housing 103 and the second device housing 104, spanning the hinge 105. Features can be incorporated into the device housing 102, including control devices, connectors, and so forth.

Also shown in FIG. 1 is an explanatory block diagram schematic 106 of the explanatory electronic device 100. In one or more embodiments, the block diagram schematic 106 is configured as a printed circuit board assembly disposed within the device housing 102 of the electronic device 100. Various components can be electrically coupled together by conductors or a bus disposed along one or more printed circuit boards.

The illustrative block diagram schematic 106 of FIG. 1 includes many different components. Embodiments of the disclosure contemplate that the number and arrangement of such components can change depending on the particular application. Accordingly, electronic devices configured in accordance with embodiments of the disclosure can include some components that are not shown in FIG. 1, and other components that are shown may not be needed and can therefore be omitted.

In one or more embodiments, the electronic device 100 includes one or more processors 107. In one embodiment, the one or more processors 107 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 112, can optionally store the executable software code used by the one or more processors 107 during operation.

The electronic device 100 also includes a communication device 109 that can be configured for wired or wireless communication with one or more other devices or networks. The networks can include a wide area network, a local area network, and/or personal area network. The communication device 109 may also utilize wireless technology for communication, such as, but are not limited to, peer-to-peer or ad hoc communications such as HomeRF, Bluetooth and IEEE 802.11, and other forms of wireless communication such as infrared technology. The communication device 109 can include wireless communication circuitry, one of a receiver, a transmitter, or transceiver, and one or more antennas.

In one embodiment, the one or more processors 107 can be responsible for performing the primary functions of the electronic device 100. For example, in one embodiment the one or more processors 107 comprise one or more circuits operable with one or more user interface devices, which can include the display 101, to present application interface portals on the display 101 from application operating on the one or more processors 107. Illustrating by example, if a videoconference application is operating on the one or more processors 107, the corresponding application interface portal may be a videoconferencing application interface portal that allows a user to engage in videoconferences by transmitting, receiving, and presenting images, video, or other presentation information.

The executable software code used by the one or more processors 107, including that associated with application operating on the one or more processors 107, can be configured as one or more modules 117 that are operable with the one or more processors 107. Such modules 117 can store instructions, control algorithms, logic steps, and so forth.

In one embodiment, the one or more processors 107 are responsible for running the operating system environment of the electronic device 100. The operating system environment can include a kernel and one or more drivers, and an application service layer, and an application layer. The operating system environment can be configured as executable code operating on one or more processors or control circuits of the electronic device 100. The application layer can be responsible for executing application service modules. The application service modules may support one or more applications or “apps,” such as media streaming applications, gaming applications, videoconference applications, business and productivity applications, webcam applications, and so forth.

The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 107 may generate commands or execute control operations based upon user input received at the user interface 110. Moreover, the one or more processors 107 may process the received information alone or in combination with other data, such as the information stored in the memory 112.

The electronic device 100 can include one or more sensors 114. The one or more sensors 114 may include a microphone, an earpiece speaker, and/or a second loudspeaker. The one or more sensors 114 may also include touch actuator selection sensors, proximity sensors, a touch pad sensor, a touch screen sensor, a capacitive touch sensor, and one or more switches. Touch sensors may be used to indicate whether any of the user actuation targets present on the display 101 are being actuated. The other sensors 114 can also include audio sensors and video sensors, one example of which is an image capture device 116.

Other components 115 operable with the one or more processors 107 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

The other components 115 can also include an audio input/processor. The audio input/processor can include hardware, executable code, and speech monitor executable code in one embodiment. The audio input/processor can include, stored in memory 112, basic speech models, trained speech models, or other modules that are used by the audio input/processor to receive and identify voice commands that are received with audio input captured by an audio input/processor, one example of which is a microphone of the one or more sensors 114. In one embodiment, the audio input/processor can include a voice recognition engine. Regardless of the specific implementation utilized in the various embodiments, the audio input/processor can access various speech models to identify speech commands in one or more embodiments.

To capture video for a content presentation companion device or other companion electronic device, such as during a videoconference, in one or more embodiments the electronic device 100 includes an image capture device 116. The electronic device 100 can optionally include a depth imager as well.

In one embodiment, the image capture device 116 comprises a two-dimensional imager configured to receive at least one image of a person within an environment of the electronic device 100. In one embodiment, the image capture device 116 comprises a two-dimensional RGB imager. In another embodiment, the image capture device 116 comprises an infrared imager. Other types of imagers suitable for use as the image capture device 116 of the electronic device 100 will be obvious to those of ordinary skill in the art having the benefit of this disclosure.

In one or more embodiments, the electronic device 100 includes a notification presentation engine 113 configured to present notifications on the display 101 when received. In one or more embodiments, the notification presentation engine 113 can perform other operations as well, examples of which include determining an area amount of the flexible display required to present a notification, reducing or eliminating superfluous portions of a notification to reduce the overall size of the notification without reducing its informational content, and determining locations and placements for the notification when presented on the display 101.

The electronic device 100 can also include a portal adjustment engine 111. In one or more embodiments. The portal adjustment engine 111 is responsible for reducing or resizing an application interface portal appearing on the display 101 when notifications are received and presented by the notification presentation engine 113. Illustrating by example, in one or more embodiments the portal adjustment engine 111 can resize an application interface portal to create a modified application interface portal so that the notification presentation engine 113 can present a notification on the display 101 adjacent to the notification in a non-overlapping arrangement with the application interface portal. Examples of how this can occur will be described below.

In other embodiments, the portal adjustment engine 111 can reduce the presentation size of the application interface portal so that the notification presentation engine 113 can present the notification adjacent to the application interface portal. The portal adjustment engine 111 can even create cutouts in the application interface portal so that the notification presentation engine 113 can present a notification in a non-overlapping arrangement adjacent to the application interface portal within the cutout. Other operations of the portal adjustment engine 111 and notification presentation engine 113 will be described below. Still others will be obvious to those of ordinary skill in the art having the benefit of this disclosure.

In one or more embodiments, the portal adjustment engine 111 and the notification presentation engine 113 comprise process engines. These process engines can be operable with the one or more processors 107. In some embodiments, the one or more processors 107 can control the portal adjustment engine 111 and notification presentation engine 113. In other embodiments, the process engines defined by the portal adjustment engine 111 and the notification presentation engine 113 can operate independently. The portal adjustment engine 111 and notification presentation engine 113 can receive data from one or both of the one or more sensors 114 and/or other components 115. In one or more embodiments, the one or more processors 107 are configured to perform the operations of the portal adjustment engine 111 and notification presentation engine 113.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other conferencing system terminal devices in accordance with embodiments of the disclosure may include various other components not shown in FIG. 1 or may include a combination of two or more components or a division of a particular component into two or more separate components, and still be within the scope of the present disclosure.

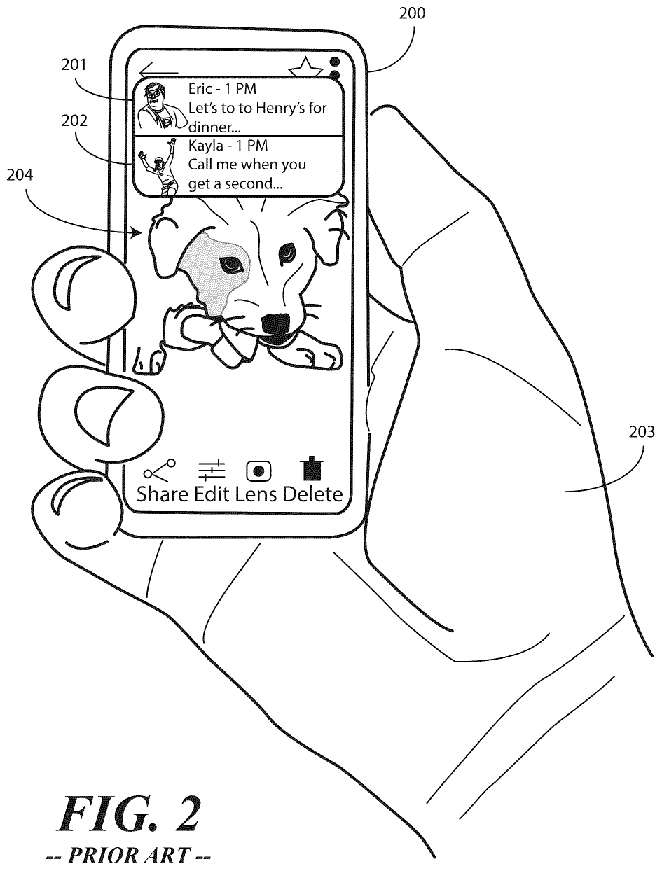

Turning now to FIG. 2, illustrated therein is a prior art electronic device 200 presenting notifications 201,202 in a conventional heads-up presentation. As shown in FIG. 2, a user 203 is enjoying a slide show 204 of photos presented in an application interface portal of a photo gallery application. Indeed, the slide show 204 is presenting a photo of the user's dog, Buster.

While this is occurring, Eric and Kayla elect to send text messages to the user 203, requesting dinner and a return phone call, respectively. Unfortunately, the presentation of these notifications 201,202 occurs directly atop Buster's head, thereby preventing the user 203 from reminiscing about the days when Buster was a puppy. This is not only aggravating, but also irritating as well. Still, using this prior art electronic device 200, the user 203 is stuck with this mode of operation, as he's not willing to turn off the notification presentation. He's been trying to contact Kayla for some time and is excited that she sent a text. However, the timing could not be worse, as the user 203 was really enjoying the moment with Buster's picture.

In such a prior art electronic device 200, most all incoming notifications 201,202 are designed to be presented in this heads-up manner where the notifications 201,202 considerably overlap the application interface portal that is being presented in the foreground and that is actively being used. In addition to simply obscuring Buster, when the application interface portal is full of user actuation targets, such as the case may be when a game is being played, presenting an overlapping notification may not only be distracting to the user, but may prevent them from catching all the action or being able to access some user actuation targets. While such notifications can be blocked, in many instances this is just not convenient, as is the case in this example.

Advantageously, embodiments of the disclosure prevent this from happening. In one or more embodiments, a method in an electronic device comprises presenting, by one or more processors on a display, an application interface portal. When the one or more processors receive a notification, in one or more embodiments the one or more processors reduce a presentation size of the application interface portal and then present the notification adjacent to the application interface portal. In one or more embodiments, the notification and the application interface portal are therefore presented in a non-overlapping arrangement. This allows the application interface portal to be viewed in full while not missing out on the notification.

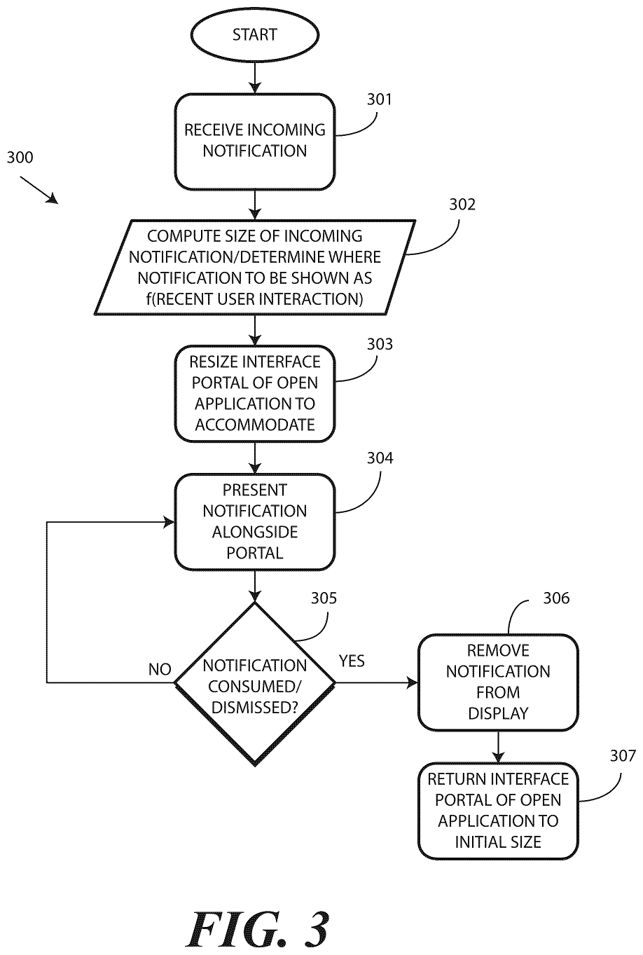

Turning now to FIG. 3, illustrated therein is one such method 300 that allows for the presentation of notifications in a non-overlapping arrangement after an application interface portal has been reduced or resized. Beginning at step 301, a communication device of an electronic device receives, or alternatively an application operating on the one or more processors of the electronic device generates, one or more notifications. Illustrating by example, a text messaging application may receive a text message and generate a notification of the text message as illustrated above in FIG. 2. The communication device may receive a phone call, in which a voice communication application may generate a notification. An exercise application operating on the one or more processors may generate a notification telling a user to stand up. An operating system may generate a notification asking a user to upgrade their software, and so forth. Thus, examples of notifications can include one of an incoming call notification, an alarm notification, an incoming message notification, an application generated notification, or a system notification. This list is illustrative only, as numerous other examples of notifications will be obvious to those of ordinary skill in the art having the benefit of this disclosure.

At step 302, the method 300 computes the size of the notification. Step 302 can comprise determining an area amount of the display required for the presentation of the notification. In one or more embodiments, this area amount is what is required to present the notification after step 302 includes reducing the notification as much as possible without eliminating or reducing the content therein. Said differently, in one or more embodiments step 302 can comprise reducing a presentation size of the notification prior to any presentation thereof.

Step 302 can also comprise determining a remaining amount of a display that may be available to present an application interface portal in an adjacent, non-overlapping arrangement with the notification. In one or more embodiments, step 302 considers the remaining area of the display as the “new” area on which to present the application interface portal. This “new” area is effectively the total area of the display minus the area required to present the notification. It can be expressed as follows: “new” area equals the total area of the display minus the area required to present the notification.

In one or more embodiments, step 303 can then comprise resizing an application interface portal actively being presented in the foreground to the new area of the display. In one or more embodiments, step 303 comprises resizing the application interface portal to create a modified application interface portal. Illustrating by example, step 303 can comprise resizing the application interface portal by scaling the application interface portal such that the modified application interface portal occupies less area of the display than the application interface portal. An example of this will be illustrated and described below with reference to FIG. 4.

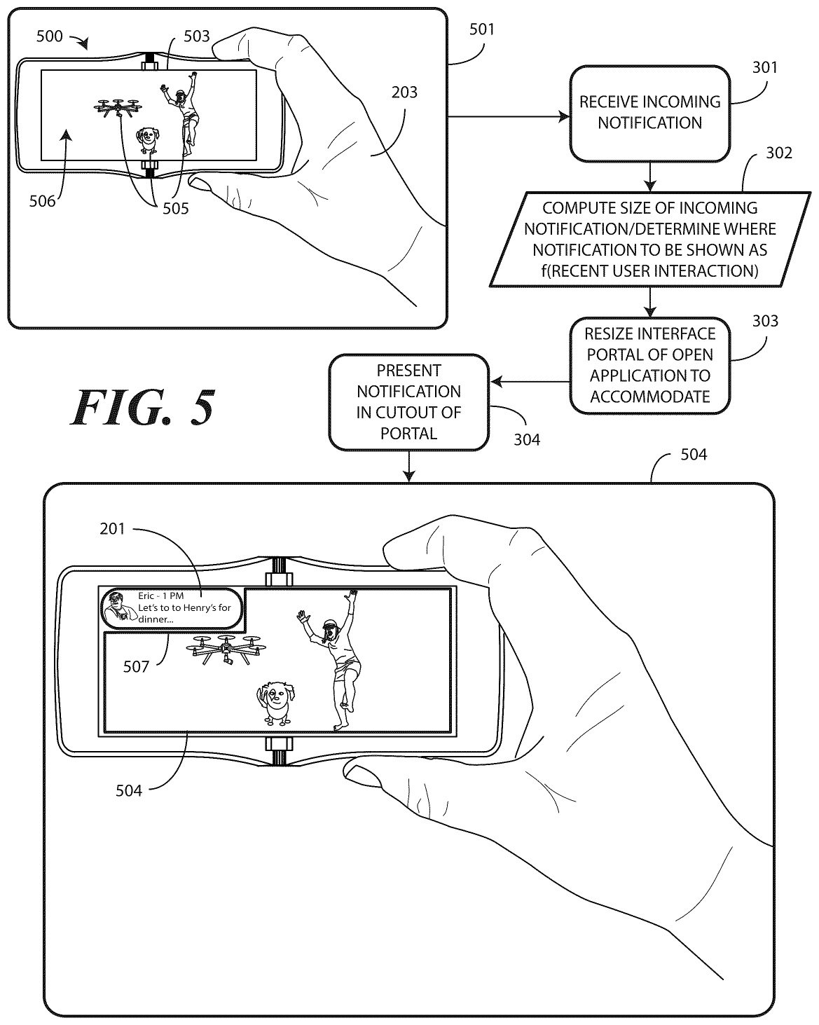

Step 303 can also comprise resizing the application interface portal by creating a cutout in the application interface portal where the notification can be presented. In one or more embodiments where the application interface portal presents both static/stationary and dynamic content, the cutout is situated in a region of the application interface portal that is presenting static or stationary content. An example of this will be illustrated and described below with reference to FIG. 5.

Since step 302 can comprise determining a presentation size of the notification, step 303 can comprise resizing the application interface portal as a function of the presentation size such that the application interface portal and notification can be presented in an adjacent, non-overlapping arrangement.

Step 304 then comprises presenting the notification on the display adjacent to the modified application interface portal. In one or more embodiments, the notification and modified application interface portal have the same aspect ratio. In one or more embodiments, the notification is presented in a cutout of the application interface portal. In one or more embodiments, the resizing occurring at step 304 occurs only when the application interface portal is one of a gaming interface portal or media consumption interface portal. In one or more embodiments, when step 304 presents the modified application interface portal and the notification, the notification and the modified application interface portal occupy substantially all of the display.

Decision 305 then determines whether consumption or dismissal of a notification being presented in a non-overlapping arrangement with a modified application interface portal occurs. Illustrating by example, a user may “swipe” the notification off the display, thereby dismissing it. Alternatively, the user may interact with the notification, thereby consuming it. Other techniques for dismissing, interacting, or otherwise causing a notification to no longer be presented on the display will be obvious to those of ordinary skill in the art having the benefit of this disclosure.

Where consumption or dismissal of the notification occurs, step 306 removes the notification from the display. Step 307 then causes the modified application interface portal to transition back to the application interface portal, and its corresponding size, that was being presented prior to the presentation of the notification.

To illustrate in further detail how the method 300 of FIG. 3 works, some examples are in order. Turning now to FIG. 4, illustrated therein are one or more method steps illustrating the presentation, by one or more processors of an electronic device 400 on a display, an application interface portal 403. When one or more notifications 201,202 are received, the one or more processors of the electronic device 400 reduce a presentation size of the application interface portal 403 to obtain a modified application interface portal 405. The one or more processors then, at step 304, present the one or more notifications 201,202 adjacent to the modified application interface portal 405. In this illustrative example, as shown at step 402, the presentation of step 304 causes the modified application interface portal 405 and one or more notifications 201,202 to be presented in a non-overlapping arrangement. Moreover, the modified application interface portal 405 and the one or more notifications 201,202 occupy substantially all of the display of the electronic device 400.

Beginning at step 401, the user 203 from FIG. 2 is again enjoying a slide show (204) of photos presented in an application interface portal 403 of a photo gallery application. Indeed, the slide show 204 is presenting a photo 404 of the user's dog, Buster. The application interface portal 403 of the photo gallery application constitutes a media consumption application interface portal because media content, such as the photo 404 of Buster, can be consumed. As noted above, in some embodiments, resizing of the application interface portal 403 in response to incoming notifications only occurs where the application interface portal comprises a media consumption application interface portal or a gaming interface portal. In other embodiments, the resizing can occur for all application interface portals.

However, in contrast to FIG. 2, the user 203 has shown a great deal of wisdom by upgrading from the prior art electronic device (200) to an electronic device 400 equipped with one or more embodiments of the disclosure. As will be seen, the user 203 is very wise indeed.

At step 301, a communication device of the electronic device 400 receives one or more notifications 201,202. For ease of illustration, the one or more notifications 201,202 of FIG. 4 are again the dinner invitation from Eric and the call-back request from Kayla. However, as noted above, notifications can be received or alternatively generated by an application operating on the one or more processors of the electronic device 400. While the one or more notifications 201,202 of FIG. 4 are generated by a text messaging application may receive a text message, other examples of notifications can include one of an incoming call notification, an alarm notification, an incoming message notification, an application generated notification, or a system notification. This list is illustrative only, as numerous other examples of notifications will be obvious to those of ordinary skill in the art having the benefit of this disclosure.

Step 302 computes the size of the one or more notifications 201,202. Step 302 can also comprise reducing the presentation size of the notification. If, for example, there is a lot of white space around a notification that is effectively only text, step 302 can comprise reducing that white space while retaining the text. In FIG. 4, each notification 201,202 comprises a small image and text. Thus, step 302 can comprise reducing any whitespace above or below these items, as well as to the left of the image and to the right of the text.

Accordingly, step 302 can comprise determining an area amount of the display required for the presentation of the one or more notifications 201,202. In one or more embodiments, this area amount is what is required to present the notifications 201,202 after step 302 includes reducing the notification as much as possible without eliminating or reducing the content therein. Said differently, in one or more embodiments step 302 can comprise reducing a presentation size of the notifications 201,202 prior to any presentation thereof.

Step 302 can also comprise determining a remaining amount of a display that may be available to present a modified application interface portal 405 in an adjacent, non-overlapping arrangement with the notifications 201,202. This area can be expressed as follows: remaining area equals the total area of the display minus the area required to present the notifications 201,202.

In one or more embodiments, step 303 can then comprise resizing the application interface portal 403 actively being presented in the foreground to the new area of the display. In one or more embodiments, step 303 comprises resizing the application interface portal 403 to create a modified application interface portal 405.

Illustrating by example, step 303 can comprise resizing the application interface portal 403 by scaling the application interface portal 403 such that the modified application interface portal 405 occupies less area of the display than the application interface portal 403. This can be seen by comparing the size of the application interface portal 403 of step 401 to the overall size of the display with the size of the modified application interface portal 405 shown in step 402 with the overall size of the display.

Since step 302 can comprise determining a presentation size of the notifications 201,202, step 303 can comprise resizing the application interface portal 403 as a function of the presentation size of the notifications 201,202 such that the modified application interface portal 405 and notifications 201,202 can be presented in an adjacent, non-overlapping arrangement as shown at step 402.

Step 304 then comprises presenting the notifications 201,202 on the display adjacent to the modified application interface portal 405. The result is shown in step 402. In one or more embodiments, the notifications 201,202 and modified application interface portal 405 have the same aspect ratio. As shown at step 402, when step 304 presents the modified application interface portal 405 and the notifications 201,202, the notifications 201,202 and the modified application interface portal 405 occupy substantially all of the display.

Advantageously, when the one or more processors of the electronic device 400 of FIG. 4 receive one or more notifications 201,202, in one or more embodiments the one or more processors reduce a presentation size of the application interface portal 403 and then present the notifications 201,202 adjacent to the modified application interface portal 405. As shown at step 402. in one or more embodiments the notifications 201,202 and the modified application interface portal 405 are therefore presented in a non-overlapping arrangement. This allows the modified application interface portal 405 to be viewed in full while not missing out on the notifications 201,202.

When the notifications are consumed, they can be removed from the display. The modified application interface portal 405 can then be increased in size to fill the void. In one or more embodiments, the increasing of the size of the modified application interface portal 405 returns the application interface portal 403 to an initial size occurring prior to receipt of the one or more notifications 201,202.

Turning now to FIG. 5, illustrated therein are one or more method steps illustrating the presentation, by one or more processors of another electronic device 500 configured in accordance with one or more embodiments of the disclosure, on a display, an application interface portal 503. The application interface portal 503 of FIG. 5 is again a media consumption portal, as it is presenting a movie via a movie streaming application operating on the one or more processors of the electronic device 500.

As shown at step 501, the application interface portal 503 presents both dynamic content 505 and stationary content 506. In this illustration, the movie shows a movie depicting Buster (he gets around, right?) and Kayla encountering a rogue drone. The drone, Buster, and Kayla are all animated and moving in this scene, and thus constitute dynamic content 505. By contrast, there is a lot of sky behind these protagonists and their antagonist drone which remains unchanging in this particular scene. Accordingly, these blue-sky images that do not change constitute stationary content 506.

As before, when the notification 201 from Eric requesting dinner (Kayla is now in the movie, so how can she send a notification without disrupting the plot?) is received, the one or more processors of the electronic device 500 reduce a presentation size of the application interface portal 503 to obtain a modified application interface portal 504. In this illustrative embodiment, step 302 determines a location where the incoming notification 201 can be presented by identifying this stationary content 506.

Accordingly, the resizing occurring at step 303 comprises creating a cutout 507 in the application interface portal 503 to create the modified application interface portal 504. In this illustrative embodiment, the cutout 507 is situated in the region of the application interface portal 503 presenting the stationary content 506. Accordingly, our dear user 203 can still enjoy the antics of Buster and Kayla dealing with this jibbing drone while seeing the notification 201 without missing any of the action.

The one or more processors then, at step 304, present the notification 201 adjacent to the modified application interface portal 504. In this illustrative example, as shown at step 502, the presentation of step 304 causes the notification 201 to be presented in the cutout 507 of the modified application interface portal 504, thereby presenting the notification 201 and the modified application interface portal 504 in a non-overlapping arrangement. Moreover, the modified application interface portal 504 and the notification 201 occupy substantially all of the display of the electronic device 500.

Beginning at step 501, our friend, the user 203, is consuming a movie presented in an application interface portal 503 of a movie streaming application. The application interface portal 503 constitutes a media consumption application interface portal because media content, such as movie, can be consumed using the aip 503.

At step 301, a communication device of the electronic device 500 receives the notification 201 from our other friend, Eric. Step 302 computes the size of the notification 201. Step 302 can also comprise reducing the presentation size of the notification 201 as previously described.

Accordingly, step 302 can comprise determining an area amount of the display required for the presentation of the notification 201. In one or more embodiments, this area amount is what is required to present the notification 201 after step 302 includes reducing the notification 201 as much as possible without eliminating or reducing the content therein.

Step 302 can also determine a location in the application interface portal 503 where the notification 201 should be presented. In this illustrative embodiment, since the application interface portal 503 is presenting both dynamic content 505 and static or stationary content 506, step 302 comprises selecting a location in the application interface portal 503 where the content presented by the application interface portal is static. Since the sky is not moving, the static content is at the stationary content 506 locations.

In one or more embodiments, step 303 can then comprise resizing the application interface portal 403 actively being presented in the foreground to the new area of the display. In one or more embodiments, step 303 comprises resizing the application interface portal 403 to create a modified application interface portal 405.

In this illustrative embodiment, step 303 comprises resizing the application interface portal 503 by creating a cutout 507 in the application interface portal 503 where the notification 201 can be presented. The cutout 507 is made at the static location so that none of the dynamic content 505 will be obscured. Since step 302 can comprise determining a presentation size of the notification 201, step 303 can comprise resizing the application interface portal 503 as a function of the presentation size such that the application interface portal 503 and notification 201 can be presented in an adjacent, non-overlapping arrangement.

Step 304 then comprises presenting the notification 201 on the display adjacent to the modified application interface portal 504. In one or more embodiments, the notification 201 and modified application interface portal 504 have the same aspect ratio. In this illustrative embodiment, the notification 201 is presented in a cutout 507 of the modified application interface portal 504. In one or more embodiments, the resizing occurring at step 304 occurs only when the application interface portal 503 is one of a gaming interface portal or media consumption interface portal, the latter of which is the case in FIG. 5. In one or more embodiments, when step 304 presents the modified application interface portal 504 and the notification 201, the notification 201 and the modified application interface portal 504 occupy substantially all of the display.

Advantageously, when the one or more processors of the electronic device 500 of FIG. 5 receives a notification 201, in one or more embodiments the one or more processors reduce a presentation size of the application interface portal 503 (in this example by creating a cutout 507) and then present the notification 201 adjacent to the resulting modified application interface portal 504. As shown at step 502, in one or more embodiments the notification 201 and the modified application interface portal 504 are therefore presented in a non-overlapping arrangement. This allows the modified application interface portal 504 to be viewed in full while not missing out on the notification 201.

When the notifications are consumed, they can be removed from the display. The modified application interface portal 504 can then be increased in size to fill the void. In one or more embodiments, the increasing of the size of the modified application interface portal 504 returns the application interface portal 503 to an initial size occurring prior to receipt of the one or more notification 201.

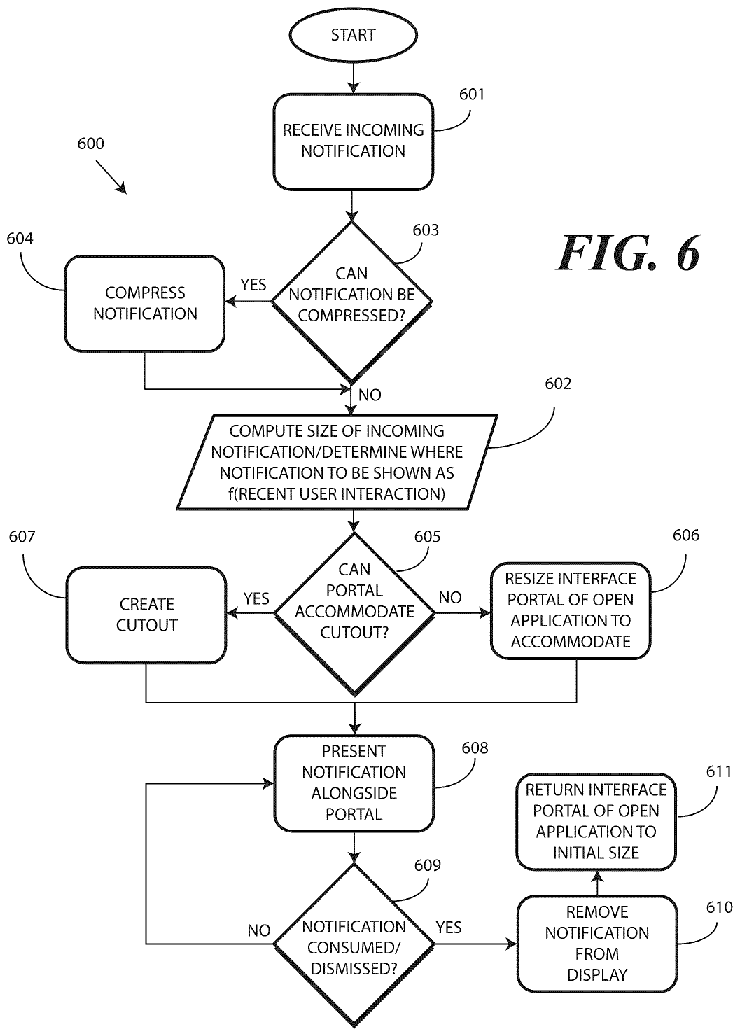

Turning now to FIG. 6, illustrated therein is another method 600 in accordance with one or more embodiments of the disclosure. The method 600 provides, in response to receipt of a notification for presentation on a display, reducing an application interface portal being presented on the display and presenting the notification in a non-overlapping arrangement adjacent to the application. The method 600 of FIG. 6 provides additional detail when an application interface portal is suitable for the creation of a cutout for the presentation of a notification, as the creation of a cutout generally results in less reduction of the size of an application interface portal compared to reducing the application interface portal without a cutout. The method 600 of FIG. 6 can be used for any type of notification, including incoming call notifications, alarm notifications, incoming message notifications, application generated notifications, system notifications, or other types of notifications.

Beginning at step 601, a communication device of an electronic device receives, or alternatively an application operating on the one or more processors of the electronic device generates, one or more notifications. Illustrating by example, a health monitoring application may generate a notification alerting a user that they should stand up to maintain a non-sedentary lifestyle. The health monitoring application may request the one or more processors present this notification on the display of the electronic device. Similarly, a communication device of an electronic device may receive a weather alert that should be presented on the display of the electronic device. A user may launch a particular application that generates, upon launch, a reminder notification requesting that the user update the application before using the same. A banking application may receive a notification indicating that the Federal Deposit Insurance Corporation has taken over the bank due to insolvency and that the user is likely to receive a twenty percent haircut on any deposited funds, and so forth. Thus, examples of notifications can include one of an incoming call notification, an alarm notification, an incoming message notification, an application generated notification, or a system notification. This list is illustrative only, as numerous other examples of notifications will be obvious to those of ordinary skill in the art having the benefit of this disclosure.

At step 602, the method 600 can perform one or more of a plurality of actions. As one example, the method 600 can compute the size of the notification and determine how much area of the display would be required to present the notification. Step 602 can also comprise determining the amount of area of the display that would remain if the notification were presented. In one or more embodiments, step 602 does this by taking the entire area available for presentation on the display and subtracts the amount of area required to present the notification. This leaves a remainder amount that would be available for a modified application interface portal of an application operating on the one or more processors to be presented. This defines an original area (the entire area available for presentation on the display) where, perhaps, an application interface portal of an application operating on the one or more processors was being presented, a notification area (the amount of area required to present the notification), and a “new” area (the area in which a modified application interface portal can be presented in a non-overlapping arrangement adjacent to the notification). These areas can be stored in a memory at step 602.

Prior to doing this determination, however, in one or more embodiments decision 603 comprises determining whether the notification can be reduced in size. If it can, step 604 comprises reducing the size of the notification. Otherwise, the method 600 moves to step 602. Illustrating by example, if the font can be reduced to a font that is not less than a minimum point font preferred by a user, step 604 can comprise reducing the font to that minimum point threshold. Similarly, step 604 can comprise removing superfluous white space from around text or images of the notification. If the notification includes a hyperlink, this hyperlink can be embedded behind a single word rather than being set forth in full. Other techniques for reducing the size of a notification at step 604 will be obvious to those of ordinary skill in the art having the benefit of this disclosure.

Once step 602 determines the size of the notification (either before or after reduction), decision 605 determines whether the application interface portal being presented by the application operating on the one or more processors can accommodate a cutout. Embodiments of the disclosure contemplate that it is not prudent to create cutouts where either action (as in a movie, television show, or other media content) is happening or user actuation targets (as in a gaming controller) are located. Thus, in one or more embodiments where the application interface portal presented by the application operating on the one or more processors presents both dynamic and stationary content, decision 605 will determine that the application interface portal can accommodate a cutout if a location where a cutout can be placed corresponds to stationary or static content and not dynamic content. Similarly, where the application interface portal presented by the application operating on the one or more processors is a gaming controller having game characters, user actuation targets, and other static content excluding these elements, decision 605 will determine that the application interface portal can accommodate a cutout if a location where a cutout can be placed corresponds to static content and not content depicting characters or presenting user actuation targets. Indeed, as noted above, in one or more embodiments the method 600 of FIG. 6 is only used to perform its resizing of the application interface portal to create a modified application interface portal at either step 606 or step 607 when the application interface portal being presented by the application operating on the one or more processors is one of a gaming interface portal or a media consumption interface portal. In other embodiments, the method 600 can be used for any type of application interface portal being presented by an application operating on the one or more processors.

Where the application interface portal being presented by the application operating on the one or more processors can accommodate a cutout, step 607 comprises reducing the application interface portal by creating a cutout in the application interface portal to create a modified application interface portal. Otherwise, step 606 comprises reducing a presentation size of the application interface portal being presented by the application operating on the one or more processors to create a modified application interface portal. In one or more embodiments, step 606 comprises scaling the application interface portal such that the modified application interface portal occupies less area of the display than did the application interface portal before the notification was received. In one or more embodiments, the size of the modified application interface portal fits within the “new” area determined at step 602. This allows the notification and modified application interface portal to be presented in a non-overlapping arrangement at step 608 with the notification adjacent to the modified application interface portal in one or more embodiments.

Decision 609 then determines if the notification is consumed or dismissed. Step 610 then removes the notification from the display. Step 611 returns the modified application interface portal to the application interface portal. In one or more embodiments, step 611 results in the presentation size of the application interface portal returning to its initial size before the notification was received. Of course, the method 600 of FIG. 6 can repeat each time a notification is received. The method 600 can also be used regardless of whether one, or multiple, notifications are received, as demonstrated above.

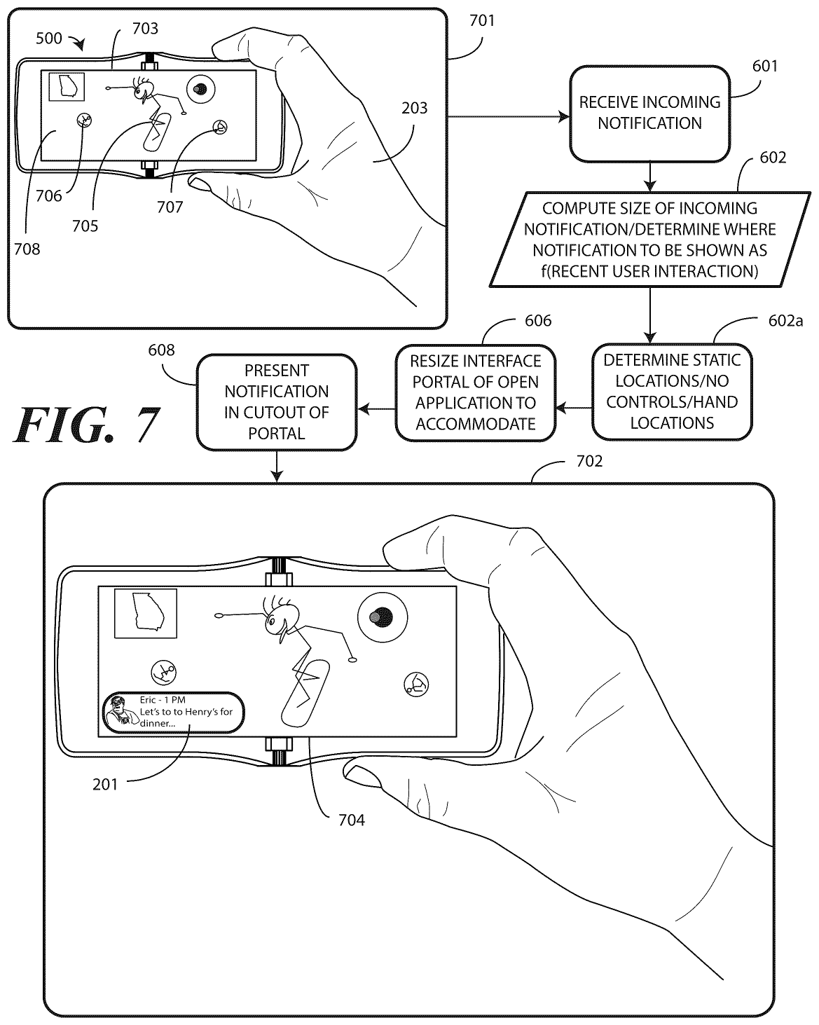

Turning now to FIG. 7, illustrated therein are one or more method steps illustrating how the method (600) of FIG. 6 can work in practice. The one or more method steps of FIG. 7 illustrate the presentation, by one or more processors of another electronic device 500 configured in accordance with one or more embodiments of the disclosure, on a display, an application interface portal 703. The application interface portal 703 of FIG. 75 is a gaming interface portal, as it is presenting snowboarding game application interface portal when the game is operating on the one or more processors of the electronic device 500.

As shown at step 701, the application interface portal 703 presents both dynamic content and static content. In this illustration, the dynamic content comprises a boarder 705 doing a booter through the air along with one or more user actuation targets 706,707 that allow a gamer to control the boarder to stomp the landing and avoid a taco. A map is presented showing where the boarder is cruising in with crunch steez. A level is presented so the gamer can determine whether the boarder is upright or inverted. After all, nobody wants to land a kicker with a wipeout that becomes a yard sale, yo.

In addition to these dynamic portions, there is a lot of static content represented by the sky through which the boarder sails. Due to the way the application operating on the one or more processors is designed, this sky background does not change substantially while the boarder crushes the booter. Accordingly, these blue-sky images that do not change constitute static content 708.

At step 601 the notification 201 from Eric requesting dinner is received (Kayla, the higher priority, has already been called back, so her notification (202) has been dismissed). Step 602 comprises determining the size of the notification 201 after a reduction in size of the notification, as well as determining an amount of area of the display of the electronic device 500 that a modified application interface portal would be able to occupy if the notification 201 were presented. In one or more embodiments, this comprises determining the static and dynamic locations of the application interface portal 703 at sub-step 602a. Sub-step 602a further comprises determining a location where the incoming notification 201 can be presented by identifying this static content 708.

In this example, the user actuation targets 706,707 and boarder 705 are positioned centrally within the application interface portal 703. The map and level are presented in the upper portions of the application interface portal 703. This leaves a sufficient amount of space beneath the left user actuation target 706 for the notification 201 to be presented within the application interface portal 703 at locations where there is an absence of user actuation targets 706,707 that are actionable by a user. Accordingly, the notification 201 can be presented in a cutout. What's more, since the notification 201 can be presented beneath the left user actuation target 706, it will be near a user's hand location so that they can act on the notification 201 without needing to move their grip.

Rather than being presented in an indention cutout as was the case in the method steps of FIG. 5, here the notification 201 can be presented in a landlocked cutout because there is a sufficient amount of static content 708 in the application interface portal 703. Accordingly, the resizing occurring at step 606 comprises creating a landlocked cutout in the application interface portal 703 to create the modified application interface portal 704. In this illustrative embodiment, the landlocked cutout is situated in the region of the application interface portal 703 presenting the static content 708. Accordingly, our dear user 203 can still enjoy have his boarder 705 perform a gnarly stomp without bailing and while still seeing the notification 201 from Eric.

The one or more processors then, at step 608, present the notification 201 in a non-overlapping arrangement with the modified application interface portal 704. In this illustrative example, as shown at step 702, the presentation of step 608 causes the notification 201 to be presented in a landlocked cutout of the modified application interface portal 704 where the modified application interface portal 704 surrounds the notification 201 in a non-overlapping arrangement. Moreover, the modified application interface portal 704 and the notification 201 occupy substantially all of the display of the electronic device 500.

Advantageously, when the one or more processors of the electronic device 500 of FIG. 7 receive a notification 201, in one or more embodiments the one or more processors reduce a presentation size of the application interface portal 703 (in this example by creating a landlocked cutout) and then present the notification 201 in a non-overlapping arrangement with the resulting modified application interface portal 704. This allows the dynamic portions of the application interface portal 703 to be viewed in full while not missing out on the notification 201.

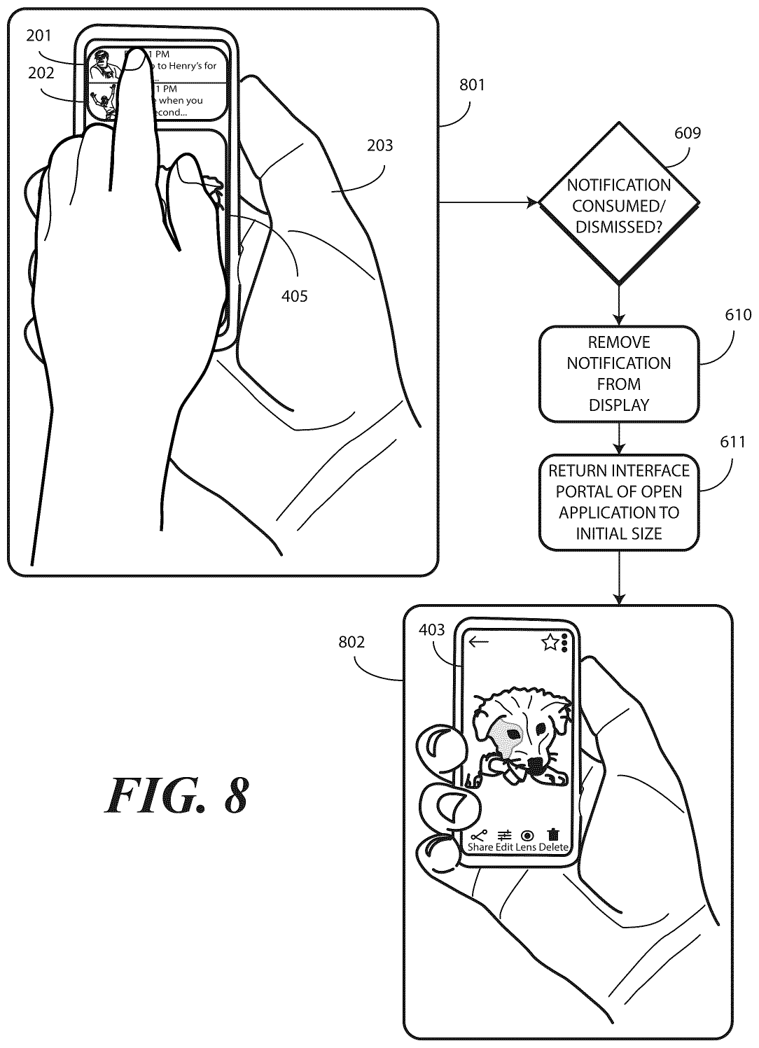

As noted above, when the notifications are consumed, they can be removed from the display. The modified application interface portal 704 can then be increased in size to fill the void. In one or more embodiments, the increasing of the size of the modified application interface portal 704 returns the application interface portal 703 to an initial size occurring prior to receipt of the one or more notification 201. Turning now to FIG. 8, illustrated therein are one or more method steps for doing this.

Beginning at step 801, our dear user 203 is dismissing the notification 201 from Eric by interacting with the notification 201 while a modified application interface portal 405 is being presented on the display. The user 203 has called Eric, confirmed dinner at Buster's Chicken Shack, and now wants to dismiss the notification 201 by swiping it away. Since Kayla has been called, her notification 202 is dismissed in a similar manner.

Decision 609 then determines if the notification 201 is consumed or dismissed. Step 610 then removes the notification 201 from the display. Step 611 returns the modified application interface portal 405 to the application interface portal 403 by expanding the modified application interface portal 405. In one or more embodiments, this expansion occurs by an amount equal to at least the area occupied by the notification 201.

Illustrating by example, had the user 203 only dismissed Eric's notification 201, while leaving Kayla's notification 202, step 611 could comprise expanding the modified application interface portal 405 to become another modified application interface portal that is large enough to fill the display other than where Kayla's notification 202 is being presented. However, in this illustration since the user 203 dismissed both the notification 201 from Eric and the notification 202 from Kayla, step 611 results in the presentation size of the application interface portal 403 returning to its initial size before the notification was received. The results are shown at step 802. Of course, these method steps can repeat each time a notification is consumed or dismissed. The method steps can also be used regardless of whether one, or multiple, notifications are dismissed at any given time.

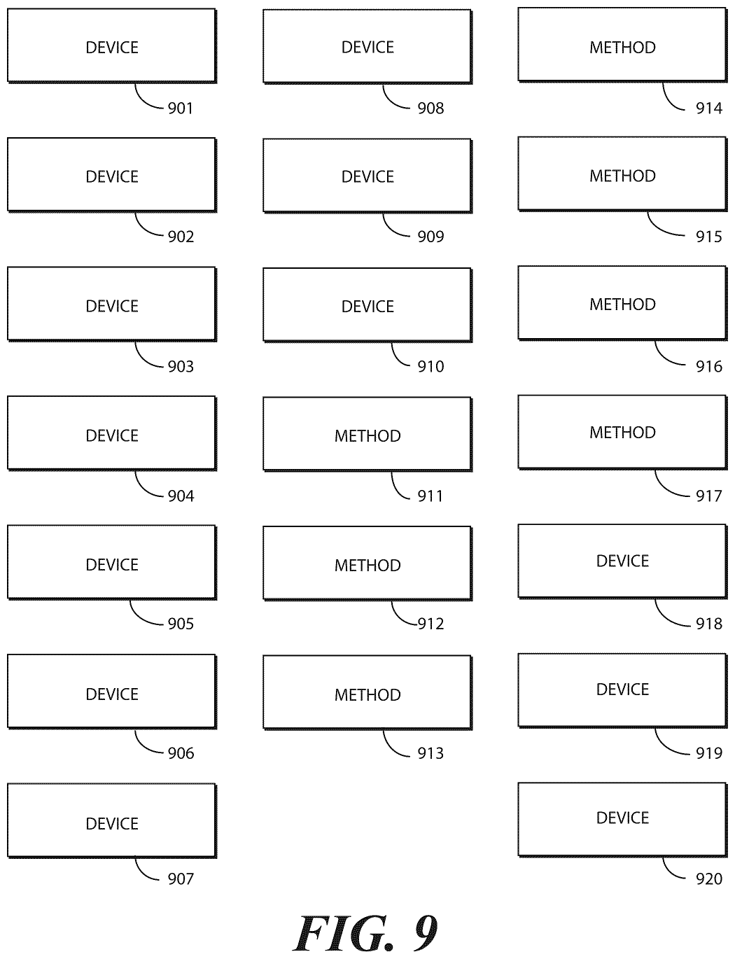

Turning now to FIG. 9, illustrated therein are various embodiments of the disclosure. The embodiments of FIG. 9 are shown as labeled boxes in FIG. 9 due to the fact that the individual components of these embodiments have been illustrated in detail in FIGS. 1-8, which precede FIG. 9. Accordingly, since these items have previously been illustrated their repeated illustration is no longer essential for a proper understanding of these embodiments. Thus, the embodiments are shown as labeled boxes.

At 901, an electronic device comprises a display and one or more processors operable with the display. At 901, the electronic device comprises a communication device operable with the one or more processors.

At 901, when an application operating on the one or more processors presents an application interface portal on the display when the communication device receives a notification, the one or more processors resize the application interface portal to create a modified application interface portal. At 901, the one or more processors present the notification on the display adjacent to the modified application interface portal.

At 902, the one or more processors of 901 resize the application interface portal by scaling the application interface portal such that the modified application interface portal occupies less area of the display than the application interface portal. At 903, the one or more processors of 901 resize the application interface portal by creating a cutout in the application interface portal.

At 904, the application interface portal of 903 presents both dynamic and stationary content. At 904, the cutout in application interface portal is situated in a region of the application interface portal presenting stationary content.

At 905, the one or more processors of 901 further reduce a presentation size of the notification prior to presenting the notification on the display adjacent to the modified application interface portal. At 906, the one or more processors of 901 further determine a presentation size of the notification. At 906, the one or more processors resize the application interface portal as a function of the presentation size of the notification.

At 907, the application interface portal of 901 and the modified application interface portal have the same aspect ratio. At 908, when the one or more processors of 901 detect consumption of the notification the one or more processors remove the notification from the display. At 908, the one or more processors cause the modified application interface portal to transition back to the application interface portal.

At 909, the one or more processors of 901 only resize the application interface portal to create the modified application interface portal when the application interface portal is one of a gaming interface portal or a media consumption interface portal. At 910, hen the modified application interface portal of 901 is presented adjacent to the notification, the notification and the modified application interface portal occupy substantially all of the display.

At 911, a method for an electronic device comprises presenting, by one or more processors on a display, an application interface portal. At 911, the method comprises receiving, by the one or more processors, a notification.

At 911, the method comprises reducing, by the one or more processors, a presentation size of the application interface portal. At 911, the method comprises presenting, by the one or more processors on the display, the notification adjacent to the application interface portal. At 912, the presenting of 911 causes the notification and the application interface portal to be presented in a non-overlapping arrangement.

At 913, the method of 911 further comprises detecting, by the one or more processors, consumption of the notification. At 913, the method of 911 further comprises removing, by the one or more processors from the display, the notification. At 913, the method of 911 further comprises increasing, by the one or more processors, the presentation size of the application interface portal.

At 914, the increasing of 913 results in the presentation size of the application interface portal returning to an initial size of the application interface portal occurring prior to receipt of the notification. At 915, the reducing of 911 comprises creating a cutout in the application interface portal.

At 916, the method of 915 further comprises determining, by the one or more processors, a location in the application interface portal where content presented by the application interface portal is static. At 916, the method comprises creating the cutout in the application interface portal at the location. At 917, the method of 911 further comprises, by the one or more processors, reducing another presentation size of the notification prior to presenting the notification on the display.

At 918, an electronic device comprises a display and one or more processors operable with the display. At 918, the one or more processors, in response to receipt of a notification for presentation on the display, reduce an application interface portal being presented on the display and present the notification in a non-overlapping arrangement adjacent to the application interface portal.

At 919, the one or more processors of 918 reduce the application interface portal by creating a cutout in the application interface portal. At 920, the notification of 918 comprises one of an incoming call notification, an alarm notification, an incoming message notification, an application generated notification, or a system notification.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. For example

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. An electronic device, comprising:
a display;
one or more processors operable with the display; and
a communication device operable with the one or more processors;
wherein when an application operating on the one or more processors presents an application interface portal on the display when the communication device receives a notification, the one or more processors resize the application interface portal to create a modified application interface portal and present the notification on the display adjacent to the modified application interface portal.

2. The electronic device of claim 1, wherein the one or more processors resize the application interface portal by scaling the application interface portal such that the modified application interface portal occupies less area of the display than the application interface portal.

3. The electronic device of claim 1, wherein the one or more processors resize the application interface portal by creating a cutout in the application interface portal.

4. The electronic device of claim 3, wherein the application interface portal presents both dynamic and stationary content, wherein the cutout in application interface portal is situated in a region of the application interface portal presenting stationary content.

5. The electronic device of claim 1, the one or more processors further reducing a presentation size of the notification prior to presenting the notification on the display adjacent to the modified application interface portal.

6. The electronic device of claim 1, the one or more processors further determining a presentation size of the notification, wherein the one or more processors resize the application interface portal as a function of the presentation size of the notification.

7. The electronic device of claim 1, wherein the application interface portal and the modified application interface portal have the same aspect ratio.

8. The electronic device of claim 1, wherein when the one or more processors detect consumption of the notification the one or more processors remove the notification from the display and cause the modified application interface portal to transition back to the application interface portal.

9. The electronic device of claim 1, wherein the one or more processors only resize the application interface portal to create the modified application interface portal when the application interface portal is one of a gaming interface portal or a media consumption interface portal.

10. The electronic device of claim 1, wherein when the modified application interface portal is presented adjacent to the notification, the notification and the modified application interface portal occupy substantially all of the display.

11. A method for an electronic device, the method comprising:
presenting, by one or more processors on a display, an application interface portal;
receiving, by the one or more processors, a notification;
reducing, by the one or more processors, a presentation size of the application interface portal; and
presenting, by the one or more processors on the display, the notification adjacent to the application interface portal.

12. The method of claim 11, wherein the presenting causes the notification and the application interface portal to be presented in a non-overlapping arrangement.

13. The method of claim 11, further comprising:
detecting, by the one or more processors, consumption of the notification;
removing, by the one or more processors from the display, the notification; and
increasing, by the one or more processors, the presentation size of the application interface portal.

14. The method of claim 13, wherein the increasing results in the presentation size of the application interface portal returning to an initial size of the application interface portal occurring prior to receipt of the notification.

15. The method of claim 11, wherein the reducing comprises creating a cutout in the application interface portal.

16. The method of claim 15, further comprising:
determining, by the one or more processors, a location in the application interface portal where content presented by the application interface portal is static; and
creating the cutout in the application interface portal at the location.

17. The method of claim 11, further comprising, by the one or more processors, reducing another presentation size of the notification prior to presenting the notification on the display.

18. An electronic device, comprising:
a display; and
one or more processors operable with the display;
the one or more processors, in response to receipt of a notification for presentation on the display, reducing an application interface portal being presented on the display and presenting the notification in a non-overlapping arrangement adjacent to the application interface portal.

19. The electronic device of claim 18, wherein the one or more processors reduce the application interface portal by creating a cutout in the application interface portal.

20. The electronic device of claim 18, wherein the notification comprises one of an incoming call notification, an alarm notification, an incoming message notification, an application generated notification, or a system notification.
